(19) United States
(12) Patent Application Publication
(10) Pub. No.: US 2015/0190938 A1
(43) Pub. Date: Jul. 9, 2015

(54) KNIFE AND SHEATH ASSEMBLY WITH REALEASABLE KNIFE SECURING FUNCTION

(71) Applicants: Russell Wilfred KOMMER, N. Fargo, ND (US); Race WU, Taichung City (TW); Thomas CRAWFORD, Gig Harbor, WA (US)

(72) Inventor: Russell Wilfred KOMMER, N. Fargo, ND (US)

(73) Assignees: Russell Wilfred KOMMER, N. Fargo, ND (US); Race WU, Taichung City (TW); Thomas CRAWFORD, Gig Harbor, WA (US)

(21) Appl. No.: 14/149,697

(22) Filed: Jan. 7, 2014

(51) Int. Cl. B26B 29/02

(52) U.S. Cl. CPC B26B 29/025

(57) ABSTRACT

A knife and sheath assembly includes a sheath including a knife receptacle defining knife-receiving open chamber, a knife stopper located at the knife receptacle and a stretchable part operable to move said knife stopper, a knife including a blade insertable into the knife-receiving open chamber, a handle and a shoulder connected between the blade and the handle and stoppable by the knife stopper to keep the blade in the knife-receiving open chamber, and an operating member including a mounting part affixed to the sheath or the knife and an actuating part connected to the mounting part and operable to force the stretchable part of the sheath against the knife stopper in direction away from the shoulder of the knife.

### BACKGROUND OF THE INVENTION

1. Field of the Invention

The present invention relates to knife technology and more particularly, to a lockable knife and sheath assembly with releasable knife securing function.

2. Description of the Related Art

Commercial knife and sheath assemblies are commonly not satisfactory in function. The sheaths of conventional knife and sheath assemblies may have no stopper means to keep the inserted knife firmly in place. Some other knife and sheath assemblies have means keep the knife firmly in the sheath, however these designs do not allow removal of the knife out of the sheath conveniently. Therefore, there is considerable room for improvement.

### SUMMARY OF THE INVENTION

The present invention has been accomplished under the circumstances in view. It is the main object of the present invention to provide a knife and sheath assembly with releasable knife securing function, which normally keeps the knife in place and prohibits the knife from falling out of the sheath and, is equipped with an operating member that is operable to release the knife from the sheath for allowing removal of the knife out of the sheath conveniently.

To achieve this and other objects of the present invention, a knife and sheath assembly in one embodiment of the invention includes a sheath including a knife receptacle defining knife-receiving open chamber, a knife stopper located at the knife receptacle and a stretchable part operable to move said knife stopper, a knife including a blade insertable into the knife-receiving open chamber, a handle and a shoulder connected between the blade and the handle and stoppable by the knife stopper to keep the blade in the knife-receiving open chamber, and an operating member including a mounting part affixed to the sheath and an actuating part connected to the mounting part and operable to force the stretchable part of the sheath against the knife stopper in direction away from the shoulder of the knife.

In an alternate form of the present invention, the mounting part of the operating member is affixed to the knife.

Thus When the operating part is not pressed, the knife stopper of the sheath is stopped against the shoulder of the knife, prohibiting the knife from being pulled out of the sheath. On the contrary, when the user presses the operating part of the operating member with the thumb to force the actuating part against the stretchable part of the sheath, the sheath collar is elastically expanded, and the knife stopper of the sheath is released from the shoulder for allowing the knife to be taken out of the sheath.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational assembly view of a knife and sheath assembly in accordance with the present invention.

FIG. 2 corresponds to FIG. 1 when viewed from another angle.

FIG. 3 is an exploded view of the knife and sheath assembly in accordance with the present invention.

FIG. 4 is a side view of the knife and sheath assembly in accordance with the present invention.

FIG. 5 is a sectional view taken along line 5-5 of FIG. 4.

FIG. 6 is a sectional view taken along line 6-6 of FIG. 4.

FIG. 7 is a sectional view taken along line 7-7 of FIG. 4.

FIG. 8 corresponds to FIG. 4, illustrating the operating part of the operating member pressed.

FIG. 9 corresponds to FIG. 5, illustrating the operating part of the operating member pressed.

### DETAILED DESCRIPTION OF THE INVENTION

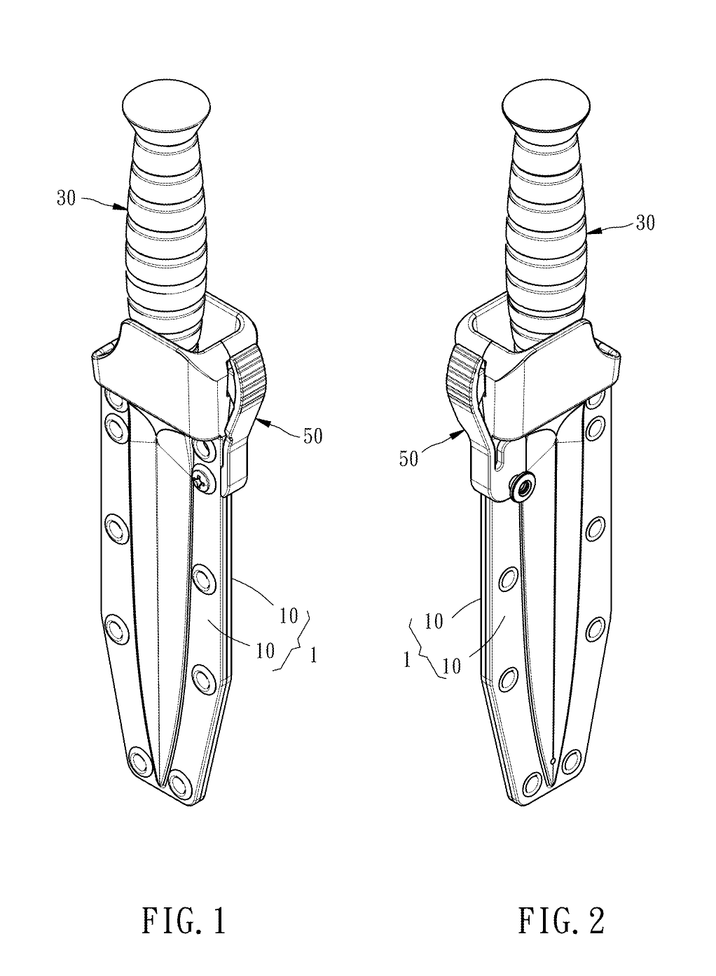

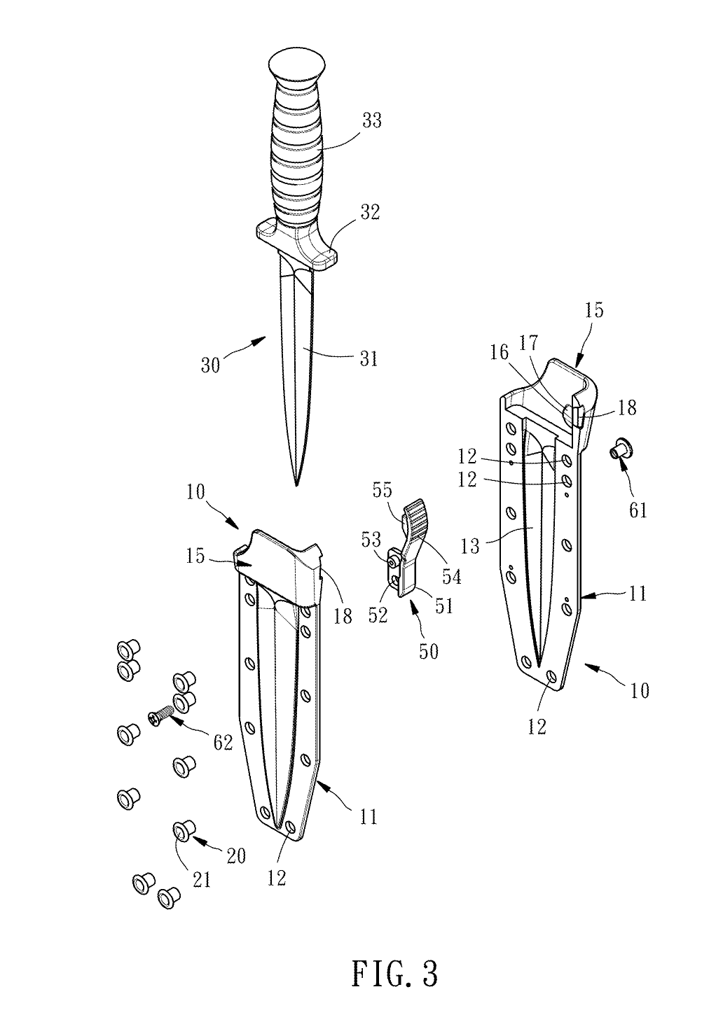

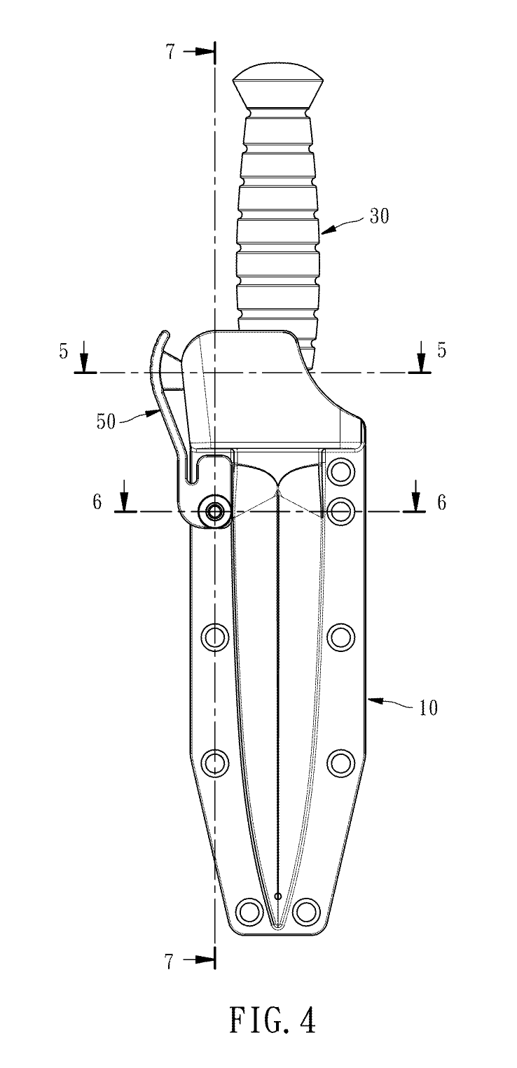

Referring to FIGS. 1-5, a knife and sheath assembly in accordance with the present invention is shown. The knife and sheath assembly comprises a sheath 1, a knife 30, and an operating member 50.

The sheath 1 is formed of two symmetrical sheath halves 10. Each sheath half 10 comprises a knife receptacle 11 defining a knife-receiving open chamber 13 and a plurality of mounting holes 12, a knife stopper 16 connected to the knife receptacle 11, and a stretchable part 18 operable to move the knife stopper 16.

As stated above, the sheath 1 is formed of the aforesaid two symmetrical sheath halves 10, and therefore, the sheath 1 comprises two knife stoppers 16. Further, the stretchable part 18 of each sheath half 10 of the sheath 1 has a beveled or arched surface 19 and form a V-shaped opening therebetween. The sheath 1 further comprises an opening-like sheath collar 15 disposed reversed to the stretchable part 18 of each sheath half 10.

Further, the two sheath halves 10 of the sheath 1 are fastened together with rivets 20. Further, each rivet 20 defines therein an axial center hole 21.

The knife 30 comprises a blade 31 insertable into the knife-receiving open chambers 13 of the two sheath halves 10 of the sheath 1, a handle 33, and shoulder 32 connected between the blade 31 and the handle 33 and stoppable by the knife stoppers 16 of the two sheath halves 10 of the sheath 1.

Each sheath half 10 of the sheath 1 further comprises a bearing surface 17 being biased by the shoulder 32 of the knife 30, the knife stopper 16 of each sheath half 10 is arranged at opposite side of said knife 30.

The operating member 50 comprises a mounting part 51 connected to the sheath 1, an operating part 54, and at least one actuating part 55. The mounting part 51 of the operating member 50 comprises a mounting hole 52 connected to the axial center hole 21 of one rivet 20, and a positioning portion 53 positioned in the axial center hole 21 of another rivet 20. The operating part 54 is operable to force the at least one actuating part 55 against the stretchable part 18 of each sheath half 10 of the sheath 1 in moving the knife stopper 16.

Further, the mounting hole 52 of the mounting part 51 of the operating member 50 is connected to the axial center hole 21 of one rivet 20 in one respective mounting hole 12 of each sheath half 10 of the sheath 1 by a first fastening member (for example, screw nut) 61 and a second fastening member (for example, screw) 62. Further, the actuating part 55 has two beveled or arched surfaces 56 and form a V-shaped wedge.

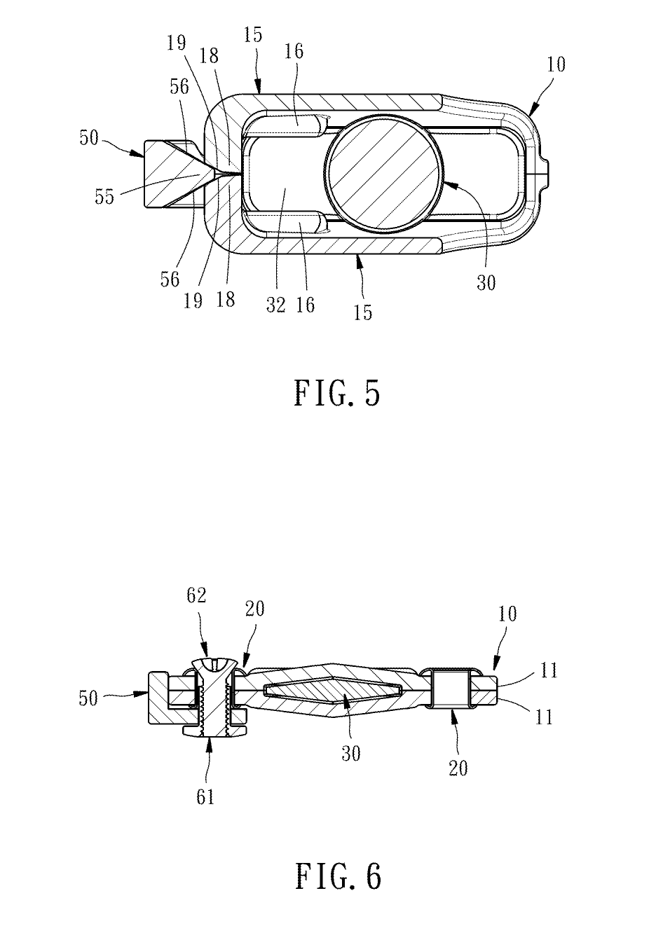

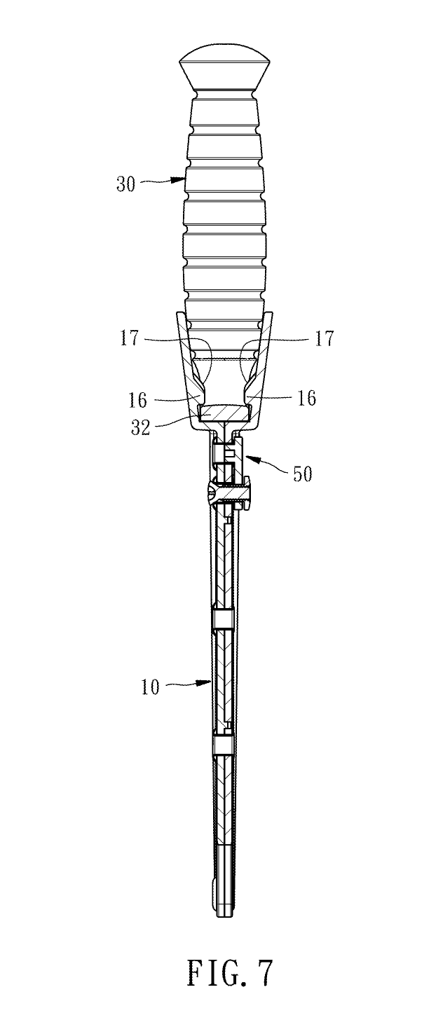

When the operating part 54 is not pressed, as shown in FIG. 5 and FIG. 7, the knife stopper 16 of each sheath half 10 of the sheath 1 is stopped against the shoulder 32 of the knife 30, prohibiting the knife 30 from being pulled out of the sheath 1.

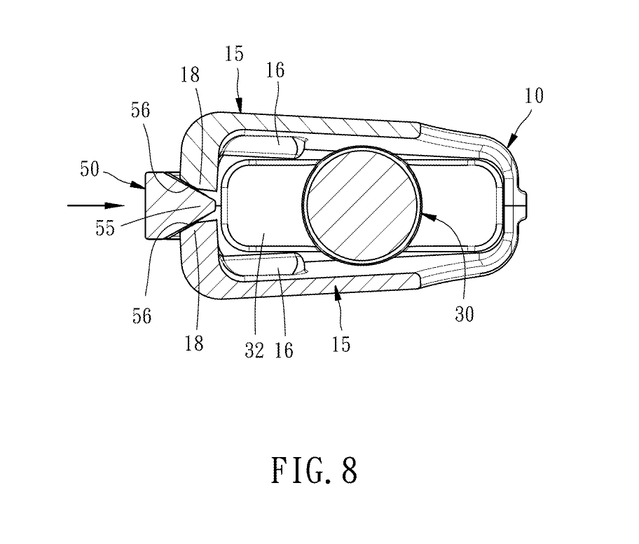

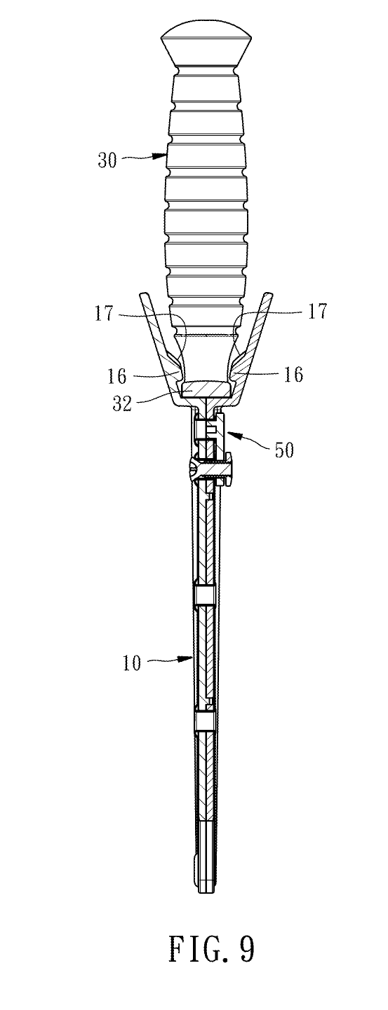

Referring to FIG. 8 and FIG. 9, when the user presses the operating part 54 of the operating member 50 with the thumb to force the actuating part 55 against the stretchable part 18 of each sheath half 10 of the sheath 1, the sheath collar 15 is elastically expanded, and the knife stopper 16 of each sheath half 10 of the sheath 1 is released from the shoulder 32 for allowing the knife 30 to be taken out of the sheath 1.

Further, the knife and sheath assembly in accordance with the present invention can also be modified in many other ways as follows:

For example, the sheath 1 can be configured to provide only one single knife stopper 16 at one lateral side.

Alternatively, the sheath 1 can be configured to provide only one single stretchable part 18 at one lateral side, and the actuating part 55 of the operating member 50 can also be configured to provide only one beveled surface or arched surface 56.

Alternatively, the operating member 50 can be configured to provide two opposing actuating parts 55.

Alternatively, the operating member 50 can be mounted in the knife 30 instead of mounting the operating member 50 in the sheath 1, for example, the mounting part 51 of the operating member 50 can be affixed to the knife 30.

Further, the stretchable part 18 of the sheath 1 can be a beveled or arched surface.

In conclusion, the invention provides a knife and sheath assembly knife and sheath assembly with releasable knife securing function, which normally keeps the knife 30 locked in the sheath 1, and which is equipped with an operating member 50 that is conveniently pressable by the user to release the knife 30 from the locking position for allowing removal of the knife 30 from the sheath 1.

What is claimed is:

1. A knife and sheath assembly, comprising:
a sheath (1) comprising a knife receptacle (11) defining therein a knife-receiving open chamber (13), at least one knife stopper (16) located at said knife receptacle (11), and a stretchable part (18) operable to move said knife stopper (16);
a knife (30) comprising a blade (31) insertable into said knife-receiving open chamber (13) of said sheath (1), a handle (33), and a shoulder (32) connected between said blade (31) and said handle (33) and stoppable by said at least one knife stopper (16) of said sheath (1) to keep said blade (31) in said knife-receiving open chamber (13); and
an operating member (50) comprising a mounting part (51) affixed to said sheath (1), and at least one actuating part (55) connected to said mounting part (51) and operable to force said stretchable part (18) of said sheath (1) against said at least one knife stopper (16) in direction away from said shoulder (32) of said knife (30).

2. The knife and sheath assembly as claimed in claim 1, wherein the number of said at least one knife stopper (16) is 2 and arranged at opposite side of said knife (30).

3. The knife and sheath assembly as claimed in claim 1, wherein said stretchable part (18) of said sheath (1) is made in one of the forms of beveled surface and arched surface (19).

4. The knife and sheath assembly as claimed in claim 1, wherein the number of said stretchable part (18) of said sheath (1) is 2, said two stretchable part (18) formed a V-shaped opening, said actuating part (55) of said operating member (50) formed a V-shaped wedge.

5. The knife and sheath assembly as claimed in claim 1, wherein each of said at least one actuating part (55) of said operating member (50) is made in one of the forms of beveled surface and arched surface (56).

6. The knife and sheath assembly as claimed in claim 1, wherein said sheath (1) is formed of two sheath halves (10), said two sheath halves (10) of said sheath (1) are fastened together with rivets (20), wherein at least one said rivet (20) defines therein an axial center hole (21).

7. The knife and sheath assembly as claimed in claim 6, wherein said operating member (50) is connected to the axial center hole (21) of one said rivet (20).

8. The knife and sheath assembly as claimed in claim 7, wherein said operating member (50) further comprises a positioning portion (53) positioned in the axial center hole (21) of one said rivet (20).

9. The knife and sheath assembly as claimed in claim 1, wherein said sheath (1) further comprises a bearing surface (17) being biased by said shoulder (32) of said knife (30).

10. The knife and sheath assembly as claimed in claim 1, wherein said operating member (50) comprises a mounting hole (52) fastened to said sheath (1).

11. The knife and sheath assembly as claimed in claim 1, wherein said sheath (1) comprises at least one mounting hole (12); said operating member (50) is fastened to at least one said mounting hole (12) of said sheath (1).

12. The knife and sheath assembly as claimed in claim 1, wherein said operating member (50) is affixed to said sheath (10) by a female type first fastening member (61) and a male type second fastening member (62).

13. A knife and sheath assembly, comprising:
a sheath (1) comprising a knife receptacle (11) defining therein a knife-receiving open chamber (13), at least one knife stopper (16) located at said knife receptacle (11), and a stretchable part (18) operable to move said at least one knife stopper (16);
a knife (30) comprising a blade (31) insertable into said knife-receiving open chamber (13) of said sheath (1), a handle (33), and a shoulder (32) connected between said blade (31) and said handle (33) and stoppable by said at least one knife stopper (16) of said sheath (1) to keep said blade (31) in said knife-receiving open chamber (13); and
an operating member (50) comprising a mounting part (51) affixed to said knife (30), and at least one actuating part (55) connected to said mounting part (51) and operable to force said stretchable part (18) of said sheath (1) against said knife stopper (16) in direction away from said shoulder (32) of said knife (30).

14. The knife and sheath assembly as claimed in claim 13, wherein the number of said at least one knife stopper (16) is 2 and arranged at opposite side of said knife (30).

15. The knife and sheath assembly as claimed in claim 13, wherein said stretchable part (18) of said sheath (1) is made in one of the forms of beveled surface and arched surface (19).

16. The knife and sheath assembly as claimed in claim 13, wherein the number of said stretchable part (18) of said sheath (1) is 2, said two stretchable part (18) formed a V-shaped opening, said actuating part (55) of said operating member (50) formed a V-shaped wedge.

17. The knife and sheath assembly as claimed in claim 13, wherein each of said at least one actuating part (55) of said operating member (50) is made in one of the forms of beveled surface and arched surface (56).

18. The knife and sheath assembly as claimed in claim 13, wherein said sheath (1) is formed of two sheath halves (10), said two sheath halves (10) of said sheath (1) are fastened together with rivets (20), wherein at least one said rivet (20) defines therein an axial center hole (21).

19. The knife and sheath assembly as claimed in claim 13, wherein said sheath (1) further comprises a bearing surface (17) being biased by said shoulder (32) of said knife (30).

20. The knife and sheath assembly as claimed in claim 13, wherein said operating member (50) is affixed to said knife (30) by a female type first fastening member (61) and a male type second fastening member (62).
